(19) United States
(12) Patent Application Publication
(10) Pub. No.: US 2010/0040022 A1
(43) Pub. Date: Feb. 18, 2010

(54) Random Access Aligned Handover

(75) Inventors: Magnus Lindstrom, Spanga (SE); Per Beming, Stockholm (SE); Gunnar Mildh, Sollentuna (SE); Joakim Bergstrom, Stockholm (SE); Walter Muller, Upplands Vasaby (SE)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/531,796

(22) PCT Filed: Jan. 14, 2008
(86) PCT No.: PCT/SE08/50037

§ 371 Date: Sep. 17, 2009

(30) Foreign Application Priority Data
Mar. 22, 2007 (SE) 0700726-3

(51) Int. Cl. H04W 36/00

(52) U.S. Cl. 370/331

(57) ABSTRACT

A method and apparatus for reducing handover interruptions when a mobile device executes handover including a random access procedure is described herein. When handover is desirable, a time offset associated with a random access opportunity is determined. The time offset relates the timing of the next random access opportunity to the frame timing of a target access point. Based on the time offset, a network element, e.g., the mobile device, a serving access point, or a mobility management entity, determines a handover start time. Handover is executed at the determined start time to generally align the beginning of the handover execution with the beginning of the next random access opportunity, and therefore, to reduce handover interruption.

### TECHNICAL FIELD

The present invention relates generally to handover of a mobile device, and more particularly, to handover interrupt times.

### BACKGROUND

A handover is a procedure used in communication networks to transfer control of a mobile device from one base station or access point to another as the mobile device moves between cells in the network. Conventionally, the mobile device measures the signal strength from the serving base station and one or more neighboring base stations and sends signal strength measurement reports to a mobility management entity. The mobility management entity determines when to handover and sends the mobile device a handover command to trigger the handover. In a “shard” handover, the mobile device disconnects from the serving base station before establishing a connection with the target base station. Once the mobile device's connection with the serving base station is terminated, the mobile device cannot send or receive data until it establishes a connection with the target base station. The time period when the mobile device is unable to send or receive data is referred to as the handover interruption.

The mobile device will typically execute a random access procedure at a random access opportunity to acquire service with the target base station. In some systems, random access opportunities occur at predetermined intervals of time. After disconnecting from the serving base station, the mobile device waits for the next random access opportunity to make a random access attempt with the target base station. The period from the time when the mobile device disconnects from the serving base station until it can make a random access attempt will vary depending on when the handover command is received. The wait may vary between 0 and T_{RA}, where T_{RA} is the maximum interval between two consecutive random access opportunities. The mobile device will be without service during this waiting period.

### SUMMARY

The present invention provides a method and apparatus for reducing the handover interruption when a mobile device needs to execute a random access procedure to obtain service with a target access point. According to various embodiments, the timing of random access opportunities in the target cell are considered in determining the start time for a handover. According to one exemplary embodiment, a method for reducing the handover interruption comprises determining a time offset associated with a random access opportunity in the target cell, and determining a start time for handover based on the time offset. In this manner, the start time for the handover may be delayed until just before the random access opportunity to reduce the handover interruption. In one exemplary embodiment, the target access point in the target cell may send the time offset to a serving access point or a mobility management entity, which then computes the start time for the handover and includes the start time in a handover command. In another exemplary embodiment, the target access point in the target cell may send the time offset to the mobile device, which may compute the start time for the handover. In either case, the mobile device delays execution of the handover until the computed start time.

### BRIEF DESCRIPTION OF THE DRAWINGS

FIG. 1 shows an exemplary wireless network according to the present invention.

FIG. 2 shows an exemplary process for executing handover at a desired start time according to the present invention.

FIG. 3 shows one exemplary handover process according to the present invention.

FIG. 4 shows another exemplary handover process according to the present invention.

FIG. 5 shows another exemplary handover process according to the present invention.

FIG. 6 shows another exemplary handover process according to the present invention.

FIG. 7 shows another exemplary handover process according to the present invention.

### DETAILED DESCRIPTION

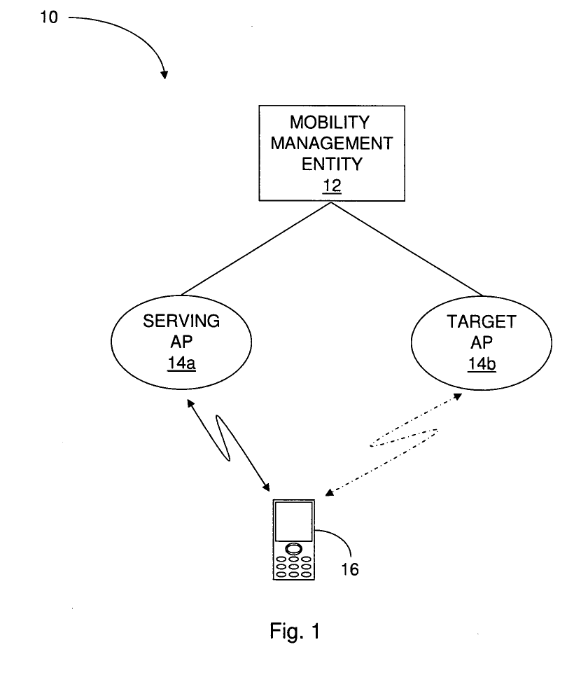

FIG. 1 shows the main elements of an exemplary wireless network 10 involved in a mobile-assisted handover. A mobile device 16 is currently served by an access point (AP) 14 referred to herein as the serving AP 14a. The mobile device 16 is moving in a direction toward a neighboring AP 14 referred to herein as the target AP 14b. While transmitting data to and receiving data from the serving AP 14a, the mobile device 16 measures the signal strength of signals received from the serving AP 14a and the target AP 14b. The mobile device 16 provides the signal strength measurements to a mobility management entity 12. Based on the signal strength measurements, the mobility management entity 12 determines when to handover control of the mobile device 16 to the target AP 14b and sends a handover message to the mobile device 16 to trigger the handover. While FIG. 1 shows a mobility management entity 12 separate from the APs 14, it will be appreciated that the mobility management entity may be co-located with one or more of the APs 14.

For a “hard” handover, mobile device 16 disconnects from the serving AP 14a at a handover start time tₛₜₐᵣₜ before establishing a connection with the target AP 14b. Once the mobile device's connection with the serving AP 14a is terminated, the mobile device 16 cannot transmit or receive data until it establishes a new connection with the target AP 14b at the handover end time t_{end}. The time period where the mobile device 16 is unable to transmit or receive data is referred to as a handover interruption Tᵢₙₜ and is defined by:

Tᵢₙₜ=t_{end}−tₛₜₐᵣₜ.

Mobile device 16 often executes a random access procedure as part of the handover process. Thus, after initiating handover at tₛₜₐᵣₜ, mobile device 16 waits for the next random access opportunity associated with the target AP 14b. At the next random access opportunity, which is designated by t₂, mobile device 16 executes the random access procedure to complete the handover. After handover is complete, mobile device 16 may resume data communications.

The waiting period between the beginning of handover at tₛₜₐᵣₜ and the next random access procedure at t₂ is represented by T_{wait} and is defined by:

T_{wait}=t₂−tₛₜₐᵣₜ.

This waiting period T_{wait} may range between 0 and T_{RA}, where T_{RA} is the maximum interval between two consecutive random access opportunities.

The present invention reduces the handover interruption Tᵢₙₜ by reducing the duration of the waiting period T_{wait}. The timing of random access opportunities in the target AP 14b are taken into account when determining the start time for a handover. More particularly, the present invention generally aligns the beginning of handover execution (tₛₜₐᵣₜ) with the beginning of a random access procedure (t₂) to reduce the waiting period T_{wait}. This allows the serving AP 14a to continue serving the mobile device 16 until just before the next random access opportunity.

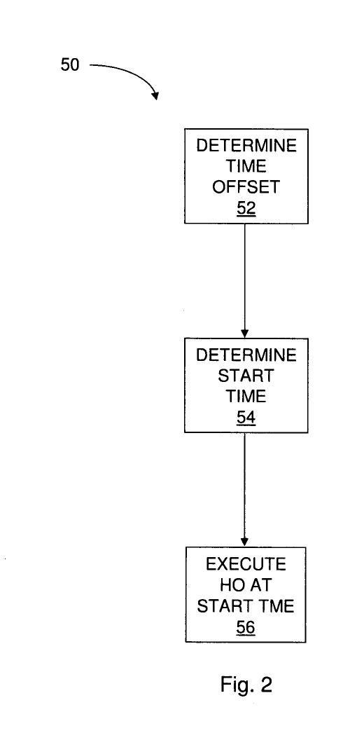

FIG. 2 shows one exemplary process 50 for reducing the handover interruption. When handover is desired, the time offset associated with the next random access opportunity is determined at the target AP 14b (block 52). The time offset may comprise the timing of the next random access opportunity relative to the frame timing of the target AP 14b. Based on the time offset, a handover start time tₛₜₐᵣₜ is determined (block 54), and handover is executed at the determined start time tₛₜₐᵣₜ (block 56). By delaying the beginning of the handover procedure until the determined start time tₛₜₐᵣₜ, the present invention reduces the handover interruption to generally exclude T_{wait} and to generally include only that time needed to implement the random access procedure. In other words, delaying handover until the determined start time tₛₜₐᵣₜ enables the mobile device 16 to participate in data communications right up until the next random access opportunity.

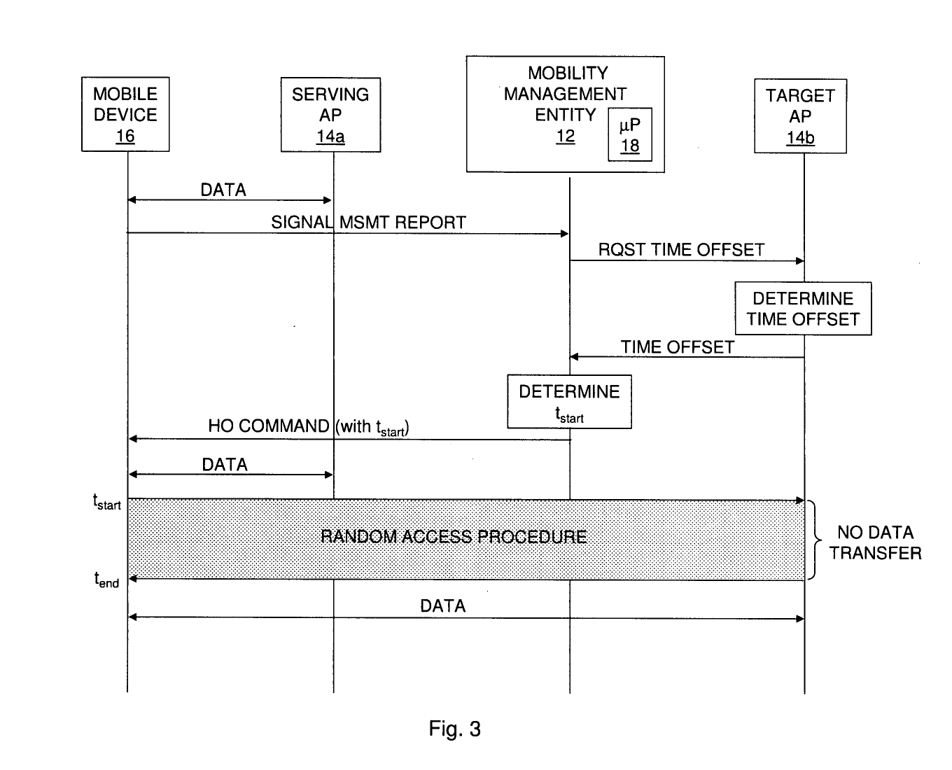

FIG. 3 shows one exemplary embodiment of the present invention where a processor 18 in the mobility management entity 12 determines the start time tₛₜₐᵣₜ based on the time offset when the frame timing of the serving and target APs 14a, 14b are synchronous. After the mobility management entity 12 determines that handover is required based on a signal strength measurement report provided by the mobile device 16, the mobility management entity 12 requests a time offset from the target AP 14b. The target AP 14b determines the time offset by comparing the beginning of the next random access opportunity to the frame timing of the target AP 14b, and sends the time offset to the mobility management entity 12. Based on the received time offset, processor 18 determines the handover start time tₛₜₐᵣₜ. The mobility management entity 12 triggers handover by sending the mobile device 16 a handover message that designates the determined start time tₛₜₐᵣₜ as the start time for the handover. The mobile device 16 executes the handover at the designated start time to generally align handover execution with the random access procedure. Alternatively, the mobility management entity 12 may send the mobile device 16 the handover message at the determined start time tₛₜₐᵣₜ, where the mobile device 16 executes the handover upon receipt of the handover message. In so doing, the present invention delays the cessation of data communications between the mobile device 16 and the serving AP 14a until right before the random access procedure begins. Data communications may resume between the mobile device 16 and the target AP 14b any time after t_{end}.

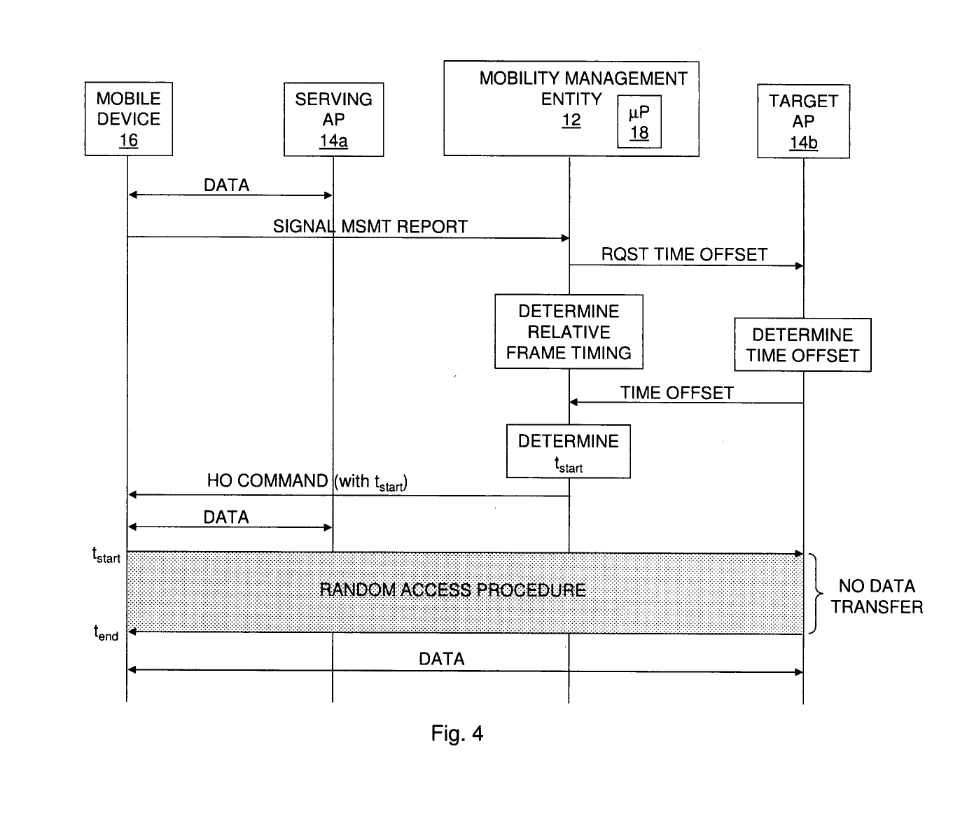

FIG. 4 shows another exemplary embodiment of the present invention where the processor 18 in the mobility management entity 12 determines the start time tₛₜₐᵣₜ based on the time offset when the frame timing of the serving and target APs 14a, 14b are non-synchronous. After the mobility management entity 12 determines that handover is required based on a signal strength measurement report provided by the mobile device 16, the mobility management entity 12 requests a time offset from the target AP 14b. The target AP 14b determines the time offset and sends the time offset to the mobility management entity 12. The processor 18 determines a relative frame timing between the serving and target APs 14. For example, the processor 18 may compare the frame timing of the serving AP 14a to the frame timing of the target AP 14b to determine the relative frame timing offset between the two APs 14. Alternatively, the processor 18 may determine the relative frame timing by receiving the relative frame timing from the mobile device 16. Based on the time offset received from the target AP 14b and the relative frame timing, the processor 18 determines the handover start time tₛₜₐᵣₜ. The mobility management entity 12 triggers handover by sending the mobile device 16 a handover message that designates the determined start time tₛₜₐᵣₜ as the start time for the handover. The mobile device 16 executes the handover at the designated start time to generally align handover execution with the random access procedure. Alternatively, the mobility management entity 12 may send the mobile device 16 the handover message at the determined start time tₛₜₐᵣₜ, where the mobile device executes handover upon receipt of the handover message. Data communications may resume between mobile device 16 and target AP 14b any time after t_{end}.

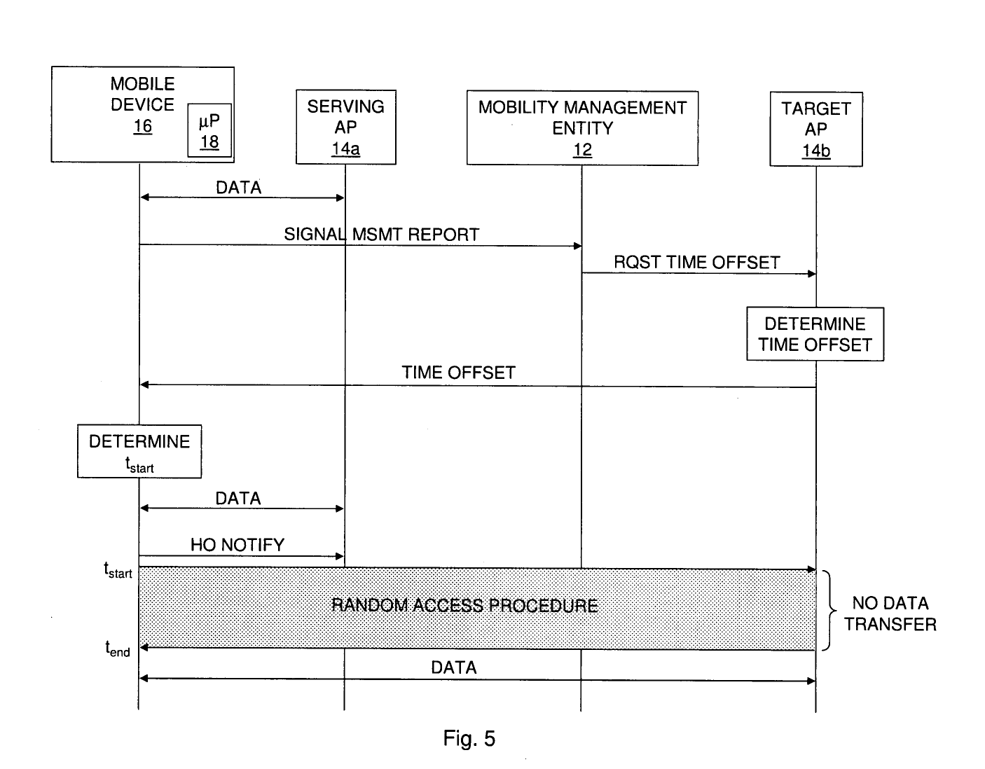

FIG. 5 shows another exemplary embodiment of the present invention where a processor 18 in the mobile device 16 determines the start time tₛₜₐᵣₜ based on the time offset when the frame timing of the serving and target APs 14a, 14b are non-synchronous. After the mobility management entity 12 determines that handover is required based on a signal strength measurement report provided by the mobile device 16, the mobility management entity 12 requests a time offset from the target AP 14b. The target AP 14b determines the time offset and sends the time offset to the mobile device 16. The target AP 14b may broadcast the time offset to the mobile device 16 or may communicate the time offset to the mobile device 16 as an information element included in a handover trigger sent to the mobile device 16 via the mobility management entity 12 and the serving AP 14a. Based on the time offset received from the target AP 14b, processor 18 determines the handover start time tₛₜₐᵣₜ and autonomously executes handover at the determined start time tₛₜₐᵣₜ. The mobile device 16 explicitly or implicitly notifies the serving AP 14a of the handover. Data communications may resume between the mobile device 16 and the target AP 14b any time after t_{end}.

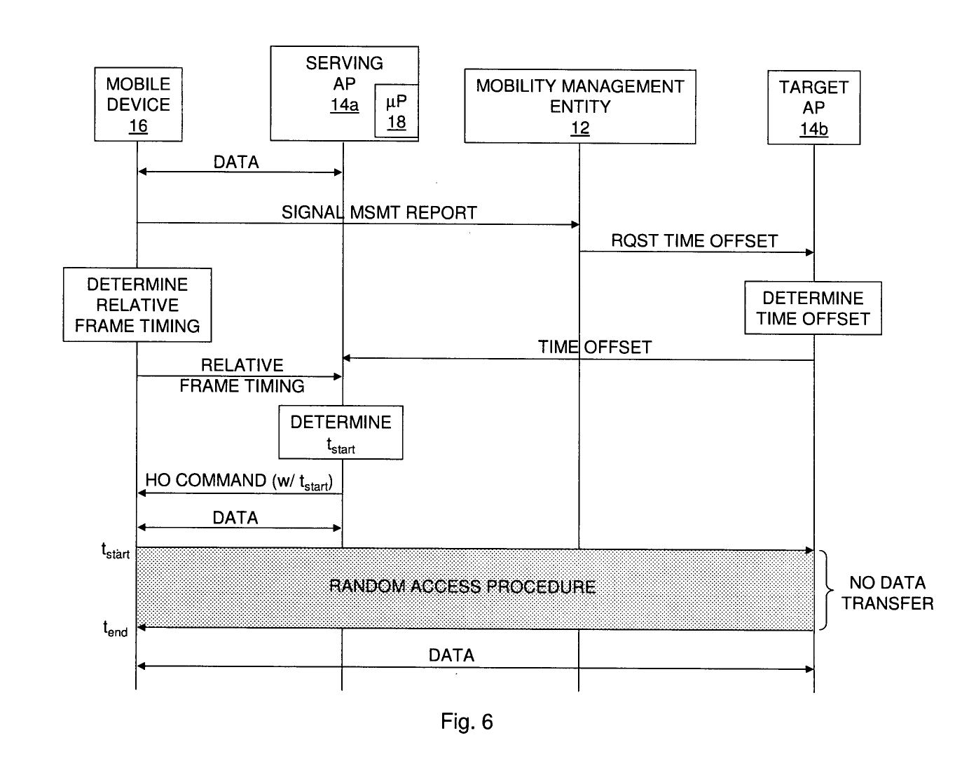

FIG. 6 shows another exemplary embodiment of the present invention where a processor 18 in the serving AP 14a determines the start time tₛₜₐᵣₜ based on the time offset when the frame timing of the serving and target APs 14a, 14b are non-synchronous. After the mobility management entity 12 determines that handover is required based on a signal strength measurement report provided by the mobile device 16, the mobility management entity 12 requests a time offset from the target AP 14b. The target AP 14b determines the time offset and sends the time offset to the serving AP 14a. In addition, the mobile device 16 determines a relative frame timing between the serving and target APs 14, and sends the relative frame timing to the serving AP 14a. For example, the mobile device 16 may compare the frame timing of the serving AP 14a to the frame timing of the target AP 14b to determine the relative frame timing offset between the APs 14. Based on the time offset received from the target AP 14b and the relative frame timing received from the mobile device 16, processor 18 determines the handover start time tₛₜₐᵣₜ. The serving AP 14a triggers handover by sending the mobile device 16 a handover message that designates the determined start time tₛₜₐᵣₜ as the start time for the handover. The mobile device 16 executes the handover at the designated start time to generally align handover execution with the random access procedure. Alternatively, the serving AP 14a may send mobile device 16 the handover message at the determined start time tₛₜₐᵣₜ, where the mobile device 16 executes the handover upon receipt of the handover message. Data communications may resume between the mobile device 16 and the target AP 14b any time after t_{end}.

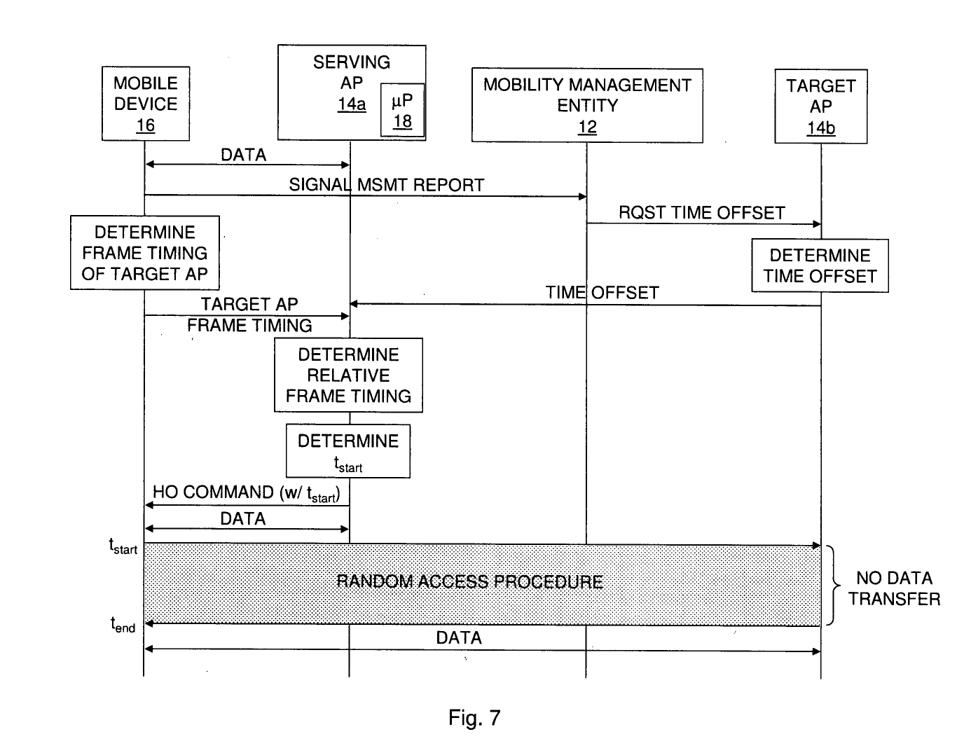

FIG. 7 shows another exemplary embodiment of the present invention where the processor 18 in the serving AP 14a determines the start time tₛₜₐᵣₜ based on the time offset when the frame timing of the serving and target APs 14a, 14b are non-synchronous. After the mobility management entity 12 determines that handover is required based on a signal strength measurement report provided by the mobile device 16, the mobility management entity 12 requests a time offset from the target AP 14b. The target AP 14b determines the time offset and sends the time offset to the serving AP 14a. In addition, the mobile device 16 determines a frame timing of the target AP 14b relative to a reference frame time known to the serving AP 14a, and sends the determined target AP frame timing to the serving AP 14a. The processor 18 determines the relative frame timing between the serving AP 14a and the target AP 14b based on its own frame timing and the received target AP frame timing. Based on the time offset received from the target AP 14b and the determined relative frame timing, processor 18 determines the handover start time tₛₜₐᵣₜ. The serving AP 14a triggers handover by sending the mobile device 16 a handover message that designates the determined start time tₛₜₐᵣₜ as the start time for the handover. The mobile device 16 executes the handover at the designated start time to generally align handover execution with the random access procedure. Alternatively, the mobility management entity 12 may send the mobile device 16 the handover message at the determined start time tₛₜₐᵣₜ, where the mobile device 16 executes the handover upon receipt of the handover message. Data communications may resume between the mobile device 16 and the target AP 14b any time after t_{end}.

While the present invention was described in the context of mobile-assisted handover, it will be appreciated that the present invention also applies to other forms of handover, including handover autonomously executed by the mobile device 16. For example, the after the mobile device 16 determines that handover is required based on received signal strength measurements, the mobile device 16 may request a time offset from the target AP 1 4b. Based on the time offset provided by the target AP 14b, a processor 18 in the mobile device 16 determines the handover start time tₛₜₐᵣₜ and autonomously executes the handover at the determined start time tₛₜₐᵣₜ.

The present invention reduces handover interruption by delaying the start of the handover execution until just before a random access opportunity in a target cell containing a target access point. Thus, the waiting period Tₛₜₐᵣₜ is reduced. The mobile device 16 may therefore continue to send and receive data until the start of the random access procedure.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A method of reducing service interruptions during handover of a mobile device in a wireless network, the method comprising:
determining a time offset associated with a random access opportunity; and
determining a start time for executing handover of the mobile device based on the time offset.

2. The method of claim 1 wherein determining the start time comprises determining the start time at a mobility management entity.

3. The method of claim 2 further comprising sending a handover message including the determined start time from the mobility management entity to the mobile device to instruct the mobile device to execute handover at the determined start time.

4. The method of claim 2 further comprising sending a handover message from the mobility management entity to the mobile device at the determined start time to instruct the mobile device to execute handover upon receipt of the handover message.

5. The method of claim 2 wherein determining the start time comprises:
receiving the time offset from a target access point at the mobility management entity; and
determining the start time at the mobility management entity based on the received time offset.

6. The method of claim 5 wherein determining the start time further comprises:
determining a relative frame timing at the mobility management entity, wherein the relative frame timing relates a frame timing of the target access point to a frame timing of a serving access point; and
determining the start time at the mobility management entity based on the relative frame timing and the received time offset.

7. The method of claim 6 wherein determining the relative frame timing comprises receiving at the mobility management entity the relative frame timing from the mobile device.

8. The method of claim 1 wherein determining the start time comprises determining the start time at the mobile device.

9. The method of claim 8 wherein determining the time offset comprises receiving the time offset from a target access point at the mobile device, and wherein determining the start time comprises determining the start time based on the received time offset.

10. The method of claim 8 further comprising executing the handover at the mobile device at the determined start time.

11. The method of claim 1 wherein determining the start time comprises determining the start time at a serving access point.

12. The method of claim 11 further comprising sending a handover message including the determined start time from the serving access point to the mobile device to instruct the mobile device to execute handover at the determined start time.

13. The method of claim 11 further comprising sending a handover message from the serving access point to the mobile device at the determined start time to instruct the mobile device to execute handover upon receipt of the handover message.

14. The method of claim 11 wherein determining the start time comprises:
receiving a relative frame timing from the mobile device at the serving access point, wherein the relative frame timing relates a frame timing of a target access point to a frame timing of the serving access point;
receiving the time offset from the target access point at the serving access point; and
determining the start time at the serving access point based on the received relative frame timing and the received time offset.

15. The method of claim 11 wherein determining the start time comprises:
receiving from the mobile device at the serving access point a frame timing of a target access point relative a reference time known to the serving access point;
determining a relative frame timing, wherein the relative frame timing relates the received frame timing of the target access point to a frame timing of the serving access point;
receiving the time offset from the target access point at the serving access point; and
determining the start time at the serving access point based on the relative frame timing and the received time offset.

16. The method of claim 1 wherein the time offset comprises an offset between the random access opportunity and a frame timing of a target access point.

17. A processor in a network element of a wireless network, said processor configured to:
determine a time offset associated with a random access opportunity; and
determine a start time for executing handover of a mobile device based on the time offset to reduce service interruptions during handover of the mobile device.

18. The processor of claim 17 wherein the network element comprises a mobility management entity.

19. The processor of claim 18 wherein the processor is further configured to send a handover message including the determined start time from the mobility management entity to the mobile device to instruct the mobile device to execute handover at the determined start time.

20. The processor of claim 18 wherein the processor is further configured to send a handover message from the mobility management entity to the mobile device at the determined start time to instruct the mobile device to execute handover upon receipt of the handover message.

21. The processor of claim 18 wherein the processor determines the start time by:
receiving the time offset from a target access point at the mobility management entity; and
determining the start time at the mobility management entity based on the received time offset.

22. The processor of claim 21 wherein processor further determines the start time by:
determining a relative frame timing at the mobility management entity, wherein the relative frame timing relates a frame timing of the target access point to a frame timing of a serving access point; and
determining the start time at the mobility management entity based on the relative frame timing and the received time offset.

23. The processor of claim 22 wherein the processor determines the relative frame timing by receiving the relative frame timing from the mobile device.

24. The processor of claim 17 wherein the network element comprises the mobile device.

25. The processor of claim 24 wherein the processor determines the time offset by receiving the time offset from a target access point, and wherein the processor determines the start time by determining the start time based on the received time offset.

26. The processor of claim 24 wherein the processor is further configured to execute the handover at the mobile device at the determined start time.

27. The processor of claim 17 wherein the network element comprises a serving access point.

28. The processor of claim 27 wherein the processor is further configured to send a handover message including the determined start time from the serving access point to the mobile device to instruct the mobile device to execute handover at the determined start time.

29. The processor of claim 27 wherein the processor is further configured to send the handover message from the serving access point to the mobile device at the determined start time to instruct the mobile device to execute handover upon receipt of the handover message.

30. The processor of claim 27 wherein the processor determines the start time by:
receiving a relative frame timing from the mobile device, wherein the relative frame timing relates a frame timing of a target access point to a frame timing of the serving access point;
receiving the time offset from the target access point; and
determining the start time based on the received relative frame timing and the received time offset.

31. The processor of claim 27 wherein the processor determines the start time by:
receiving from the mobile device a frame timing of a target access point relative to a reference time known to the serving access point;
determining a relative frame timing, wherein the relative frame timing relates the received frame timing of the target access point to a frame timing of the serving access point;
receiving the time offset from the target access point; and
determining the start time based on the relative frame timing and the received time offset.

32. The processor of claim 17 wherein the time offset comprises an offset between the random access opportunity and a frame timing of a target access point.
